(19) United States
(12) Patent Application Publication
(10) Pub. No.: US 2016/0041393 A1
(43) Pub. Date: Feb. 11, 2016

(54) Video Display Device And Head-Mounted Display

(71) Applicant: KONICA MINOLTA, INC., Tokyo (JP)

(72) Inventor: Yoshihiro INAGAKI, Chiyoda-ku (JP)

(21) Appl. No.: 14/779,404

(22) PCT Filed: Mar. 11, 2014
(86) PCT No.: PCT/JP2014/056241

§ 371 Date: Sep. 23, 2015

(30) Foreign Application Priority Data
Mar. 26, 2013 (JP) 2013-064587

(51) Int. Cl. G02B 27/01; G03H 1/02; G03H 1/22; G02B 27/42

(52) U.S. Cl. CPC G02B 27/0172; G02B 27/4211; G03H 1/0248; G03H 1/2294; G02B 2027/0174; G02B 2027/0178; G02B 2027/0107; G02B 2027/0116; G02B 2027/013

(57) ABSTRACT

A video display device is provided with: a display element which modulates light from an illumination optical system, and displays video; and an ocular optical system for guiding video light from the display element into a pupil of an observer. The ocular optical system is provided with: an ocular prism which guides the video light therein; and a holographic optical element (HOE). The HOE is provided abutting the ocular prism, and is a volume-phase-type hologram which diffracts and reflects the video light guided inside the ocular prism. A surface of the ocular prism, said surface abutting the HOE, has a curvature of 0 in one direction, and has a curvature which is not 0 in a direction orthogonal to the one direction. The diffraction power of the HOE is not 0 in the one direction, and is 0 in the direction orthogonal to the one direction.

### TECHNICAL FIELD

The present invention relates to video display devices which allow an observer to observe an image displayed on a display element as a virtual image, and to head-mounted displays (hereinafter abbreviated to as HMDs) provided with such video display devices.

### BACKGROUND ART

Conventionally, there have been proposed various types of video display devices that employ a volume-phase hologram (HOE, holographic optical element) so that image light from a display element is diffracted and reflected by the HOE to be directed to an observer's pupil, thereby to allow an observer to observe an image (virtual image). For example, according to Patent Document 1, a planar HOE is attached to an eyepiece prism, and image light emergent from the display element and guided inside the eyepiece prism is diffracted and reflected by the HOE so as to be directed to the observer's pupil.

Generally, HOEs have wavelength dependence, meaning that diffraction direction varies with wavelength. Thus, in a configuration as disclosed in Patent Document 1, in which the direction in which the image light is reflected on the HOE attachment surface of the eyepiece prism substantially aligns with the direction in which the image light is diffracted by the HOE at the center of the screen (the center of the angle of view at the time of image observation), using a planar HOE results in the image light being dispersed in terms of wavelength in radial directions about the center of the screen. In particular, in a case where light of three colors, namely red (R), green (G), and blue (B), are used as the image light, and when each of R, G, and B light has a predetermined wavelength width, the above-described wavelength dispersion occurs with each of R, G, and B light. This inconveniently leads to a problem in which a point (image) displayed at a position other than the center of the screen expands in radial directions from the center of the screen, resulting in degraded image quality.

As a solution to the problem, according to Patent Document 2, the HOE attachment surface is formed as a cylindrical surface. Moreover, to make the observation optical system slim, the cylindrical surface is given an increasingly small radius of curvature the farther from the center of the screen.

### LIST OF CITATIONS

### Patent Literature

### Patent Document 1: JP-A-2007-11279 (see FIGS. 1, 3, 4, etc.)

### Patent Document 2: JP-A-2012-13908

### SUMMARY OF THE INVENTION

### Technical Problem

According to Patent Document 2, however, it is necessary to employ the optical power of the HOE to correct aberration occurring on the HOE attachment surface. Thus, though wavelength dispersion is alleviated, no small part of it remains. Moreover, as for aberration occurring on the HOE attachment surface, it can be corrected by the optical power of the HOE with respect to rays close to principal ray, but is difficult to correct with respect to rays far from the principal ray. This results in coma aberration.

Devised against the background discussed above, an object of the present invention is to provide a video display device that can alleviate image quality degradation due to wavelength dependence of an HOE and aberration by restricting the direction in which an image expands due to wavelength independence of the HOE, and to provide an HMD provided with such a video display device.

### Means for Solving the Problem

A video display device according to one aspect of the present invention includes a display element which displays an image by modulating light from an illumination optical system, and an eyepiece optical system which directs image light from the display element to an observer's pupil. The eyepiece optical system includes an eyepiece prism which guides the image light inside the eyepiece prism, and a volume-phase hologram which is arranged in contact with the eyepiece prism and which reflects and diffracts the image light guided inside the eyepiece prism. A surface of the eyepiece prism with which the volume-phase hologram makes contact has a zero curvature in one direction, but has a non-zero curvature in a direction perpendicular to the one direction. The volume-phase hologram has a non-zero diffractive power in the one direction, but has a zero diffractive power in the direction perpendicular to the one direction.

Of surfaces which form the eyepiece prism, those which transmit the image light preferably are, except the surface with which the volume-phase hologram makes contact, flat surfaces.

The display element preferably has a rectangular display surface, and a shorter-side direction of the display surface preferably aligns with the one direction in which the surface with which the volume-phase hologram makes contact has a zero curvature.

A head-mounted display according to another aspect of the present invention includes the above-described video display device, and a support member which supports the video display device in front of an eye of an observer.

### Advantageous Effects of the Invention

Setting the curvature of the surface of the eyepiece prism with which the HOE makes contact and the diffractive power of the HOE as described above makes it possible to restrict to only one direction the direction in which a point (image) at a position other than the center of the screen expands due to wavelength independence of the HOE. This helps alleviate image quality degradation due to wavelength dependence of the HOE as compared with the conventional configuration where a planar HOE is employed. Moreover, the HOE has a zero diffractive power in the perpendicular direction, and this helps reduce aberration.

### BRIEF DESCRIPTION OF DRAWINGS

FIG. 1 A sectional view showing an outline of a structure of a video display device embodying the present invention.

FIG. 2 A perspective view showing an outline of a structure of an HMD provided with the video display device.

### DESCRIPTION OF EMBODIMENTS

Hereinafter, one embodiment of the present invention will be described with reference to the accompanying drawings.

(Video Display Device)

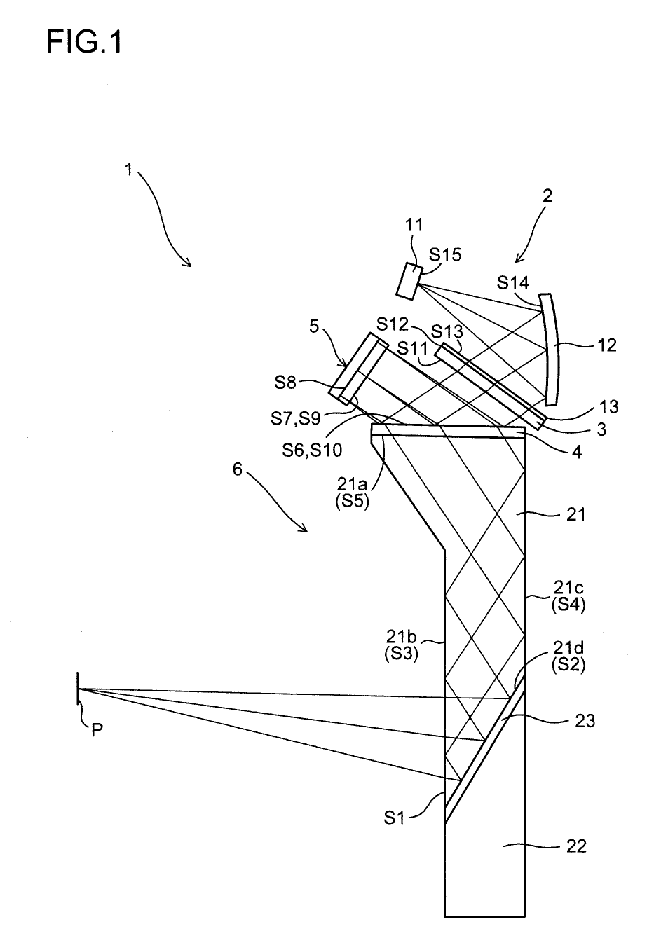

FIG. 1 is a sectional view showing an outline of a structure of a video display device 1 according to the embodiment. The video display device 1 includes an illumination optical system 2, a polarizing plate 3, a polarizing beam splitter (PBS) 4, a display element 5, and an eyepiece optical system 6.

For the sake of convenience of description, directions are defined as follows. The axis which optically connects the center of the optical pupil P formed by the eyepiece optical system 6 to the center of the display surface of the display element 5, along with any extension line of that axis, is referred to as the optical axis. The direction perpendicular to the optical axis incidence plane of an HOE 23 in the eyepiece optical system 6 is referred to as the X direction. The optical axis incidence plane of the HOE 23 refers to the plane that includes the optical axes of the light incident on and reflected from the HOE 23. The direction perpendicular to the X direction on the plane perpendicular to the line normal to a surface at the intersection of an optical member with the optical axis is referred to as the Y direction.

The illumination optical system 2 serves to illuminate the display element 5, and includes a light source 11, an illumination mirror 12, and a diffuser plate 13.

The light source 11 comprises an integrated RGB LED which emits light corresponding to R (red), G (green), and B (blue) colors. A plurality of emission points (respective emission points of R, G, and B light) are arranged substantially on a straight line in the horizontal direction (the X direction). The wavelengths of light emitted from the light source 11 are, for example, when expressed in terms of intensity peak wavelength combined with half-intensity wavelength width, in the ranges of 462±12 nm (B light), 525±17 nm (G light), and 635±11 nm (R light).

In this embodiment, the light source 11 is provided with two integrated RGB LEDs. The emission points are arranged substantially on a straight line such that, for each of R, G, and B light, the emission points are located symmetrically with respect to the optical axis incidence plane of the HOE 23 (for example, the emission points are arranged in the order BGRRGB in the X direction). This helps make the intensity distribution of the RGB light symmetric in the X direction.

The illumination mirror 12 is an optical element which reflects the light (illumination light) emitted from the light source 11 toward the diffuser plate 13, and which simultaneously bends the illumination light such that the optical pupil P and the light source 11 are substantially conjugate with each other with respect to the Y direction.

The diffuser plate 13 is an unidirectional diffuser plate which diffuses the light, for example, at 40° in the X direction, in which the plurality of the emission points of the light source 11 are arranged, but does not diffuse the incident light in the Y direction. The diffuser plate 13 is held on the surface of the polarizing plate 3.

The polarizing plate 3 transmits, out of the light incident via the diffuser plate 13, light with a predetermined polarization direction to direct it to the PBS 4.

The PBS 4 is a flat plate-shaped polarizing beam splitter which on one hand reflects the light transmitted through the polarizing plate 3 in the direction of the reflective display element 5 and which on the other hand transmits, out of the light reflected from the display element 5, light corresponding to an ON-state of an image signal (light of which the polarization direction is orthogonal to that of the light transmitted through the polarizing plate 3), and is attached to a light incidence surface 21a of an eyepiece prism 21, which will be described later, in the eyepiece optical system 6.

By attaching the PBS 4 to the light incidence surface 21a, it is possible to arrange the respective optical members in a good balance on the light incidence side and the light emergence side of the PBS 4. This helps stabilize the holding positions of the optical members. It is also possible to design such that the display element 5 is arranged in a free space above the eyepiece optical system 6. This allows efficient use of space, and is advantageous in size reduction. Moreover, attaching the PBS 4 to the eyepiece prism 21 helps reduce the area of the interface between the eyepiece prism 21 and air (the surface of direct contact with air). This helps reduce surface reflection at the above-mentioned interface and thereby improve light use efficiency, and also helps reduce ghosts resulting from surface reflection.

The display element 5 is a display element which displays an image by modulating the light from the illumination optical system 2, and in this embodiment, it comprises a reflective liquid crystal display element. The display element 5 may be configured to have color filters, or may be configured to be driven on a time-division basis for each of R, G and B at a time.

The display element 5 is arranged such that the light incident substantially perpendicularly from the PBS 4 is reflected substantially perpendicularly toward the PBS 4. Thus, compared with a configuration where light is incident at a large incidence angle with respect to a reflective display element, it is easier to obtain an optical design that offers increased resolution. The display element 5 has a rectangular display surface, and is arranged such that the longitudinal direction of the display surface aligns with the X direction and that the shorter-side direction of the display surface aligns with the Y direction.

Moreover, the display element 5 is arranged on the same side as the light source 11 with respect to the optical path from the illumination mirror 12 to the PBS 4. Thus, the entire optical system from the illumination optical system 2 to the display element 5 can be configured to be compact. The display element 5 may be supported by the same substrate as that supporting the light source 11, or may be supported by a different substrate (in FIG. 1, no substrates supporting the light source 11 and the display element 5 are illustrated).

The eyepiece optical system 6 is an optical system for directing the image light from the display element 5 to an observer's pupil (the optical pupil P), and has a non-axisymmetric (non-rotation-symmetric) positive optical power. This eyepiece optical system 6 includes the eyepiece prism 21, a deflection prism 22, and the HOE 23.

The eyepiece prism 21 serves, on one hand, to guide inside it the image light which is incident via the PBS 4 from the display element 5 and, on the other hand, to transmit the light of the outside-world image (outside light), and is configured in the shape of a plane-parallel plate of which an upper part has increasing thickness toward the upper end and of which a lower part has decreasing thickness toward the lower end.

Of the eyepiece prism 21, the surface to which the PBS 4 is attached is the light incidence surface 21a on which the image light from the display element 5 is incident, and the two surfaces 21b and 21c located substantially parallel to the optical pupil P and facing away from each other are total reflection surfaces that guide the image light by total reflection. Of these two surfaces, the surface 21b on the optical pupil P side serves also as the emergence surface of the image light diffracted and reflected by the HOE 23.

The eyepiece prism 21 and the deflection prism 22 are bonded together with adhesive so as to sandwich the HOE 23, which is arranged at the lower end of the eyepiece prism 21. In this embodiment, of the surfaces which form the eyepiece prism 21, those which transmit the image light are, except the surface 21d with which the HOE 23 makes contact, (namely the light incidence surface 21a and the surface 21b are) flat surfaces. Of the eyepiece prism 21, the surface 21d with which the HOE 23 makes contact has a shape as will be described later.

The deflection prism 22 and the eyepiece prism 21 are bonded together via the HOE 23 to substantially form a plane-parallel plate. Owing to the deflection prism 22 and the eyepiece prism 21 being bonded together, it is possible to cancel the refraction by the deflection prism 22 to which the outside light is subjected when being transmitted through the wedge shaped lower part of the eyepiece prism 21. This helps prevent the observed outside-world image from being distorted.

The HOE 23 is a volume-phase reflective hologram optical element which is arranged in contact with the eyepiece prism 21 and which reflects and diffracts the image light guided inside the eyepiece prism 21. The HOE 23 diffracts (reflects) light in three wavelength ranges of, for example, when expressed in terms of diffraction efficiency peak wavelength combined with half-diffraction efficiency wavelength width, 465±5 nm (B light), 521±5 nm (G light), and 634±5 nm (R light). Thus, the diffraction wavelengths of the HOE 23 for RGB substantially correspond to the wavelengths of the RGB image light (the emission wavelengths of the light source 11).

In the above-described configuration, the light emitted from the light source 11 in the illumination optical system 2 is reflected on the illumination mirror 12, and is then diffused only in the X direction by the diffuser plate 13; then light with a predetermined polarization direction alone is transmitted through the polarizing plate 3. The light transmitted through the polarizing plate 3 is then reflected on the PBS 4 to be incident on the display element 5.

In the display element 5, the incident light is modulated according to an image signal. Here, the image light corresponding to an ON-state of the image signal emerges from the display element 5 after being converted by it into light with a polarization direction orthogonal to that of the incident light; thus, this light is transmitted through the polarizing beam splitter 4 and enters the eyepiece prism 21 through the light incidence surface 21a. On the other hand, the image light corresponding to an OFF-state of the image signal emerges from the display element 5 without being subject to any conversion in terms of polarization direction; thus, this light is intercepted by the PBS 4 and does not enter the eyepiece prism 21.

In the eyepiece prism 21, the incident image light is totally reflected once on each of the opposite surfaces 21c and 21b of the eyepiece prism 21, and is then incident on the HOE 23, where the light is diffracted and reflected so as to exit from the eyepiece prism 21 through the surface 21b to reach the optical pupil P. Thus, at the position of the optical pupil P, an observer can observe the image displayed on the display element 5 as a virtual image.

On the other hand, the eyepiece prism 21, the deflection prism 22, and the HOE 23 transmit almost all the outside light so that an observer can observe the outside-world image on a see-through basis. Thus, the virtual image of the image displayed on the display element 5 is observed in a form superimposed on a part of the outside-world image.

(Shape of HOE Attachment Surface, and HOE's Diffractive Power)

In this embodiment, the surface 21d of the eyepiece prism 21 with which the HOE 23 makes contact is configured as a surface having a zero curvature in one direction, namely in the Y direction, but having a non-zero curvature in the direction perpendicular to the one direction, namely in the X direction. Moreover, the HOE 23 is configured to have a non-zero (for example, positive) diffractive power (optical power) in the Y direction, but have a zero diffractive power in the X direction.

Setting the shape of the surface 21d of the eyepiece prism 21 and the diffractive power of the HOE 23 as described above has the following effects: in the X direction, the image light which emerges from the display element 5 to be incident on the HOE 23 is reflected at an angle close to regular reflection so as to be directed to the optical pupil P, and wavelength dispersion due to wavelength dependence (diffractive power) of the HOE 23 can be prevented; on the other hand, in the Y direction, the image light which emerges from the display element 5 to be incident on the HOE 23 is reflected by the diffractive power of the HOE 23 so as to be directed to the optical pupil P, and thus wavelength dispersion due to diffraction on the HOE 23 occurs. In this way, wavelength dispersion does not occur in the X direction, and occurs only in the Y direction; thus, when the image is observed, a point displayed at a position other than the center of the screen expands only in the Y direction.

That is, in this embodiment, the direction in which the image is enlarged due to wavelength dependence of the HOE 23 is restricted to the Y direction as distinct from the conventional radial directions. Thus, it is possible to alleviate deterioration of image quality as compared with the conventional configuration where the image expands in radial directions. Moreover, the HOE 23 has a zero diffractive power in the X direction, and this makes it possible to reduce aberration attributable to the diffractive power of the HOE 23.

The HOE 23 is fabricated by attaching a film-form hologram photosensitive material to the surface 21d, then exposing it to two light beams, and then making the two light beams interfere with each other. When the surface 21d has a curvature only in one direction (the X direction), advantageously, the film-form hologram photosensitive material can be attached to the surface 21d easily.

Moreover, in this embodiment, the direction in which the image light is reflected on the surface 21d of the eyepiece prism 21 with which the HOE 23 makes contact is substantially aligned with the direction in which the image light is diffracted by the HOE 23 at a position corresponding to the center of the screen (the center of the display image) in the HOE 23. In this case, setting the shape of the surface 21d of the eyepiece prism 21 and the diffractive power of the HOE 23 as described above allows, even at a position deviated from the center of the screen in the X direction, the direction in which the image light is reflected on the surface 21d is substantially aligned with the direction in which the image light is diffracted by the HOE 23. Thus, at the center of the screen or at any position deviated from it in the X direction, the displayed point (image) does not expand in either direction. On the other hand, at a position deviated in the Y direction from the center of the screen or a position deviated from it in the X direction, the point expands in the Y direction, the amount by which the point expands depends on the amount by which the position is deviated in the Y direction from the center of the screen.

Moreover, when the direction in which the image is enlarged is the Y direction, by aligning the Y direction with a direction with a narrow angle of view, it is possible to minimize image deterioration. In this embodiment, the display element 5 is arranged such that the shorter-side direction of the rectangular display surface aligns with the Y direction; thus, the shorter-side direction of the display surface (a direction with a narrow angle of view) and the direction in which the surface 21d has a zero curvature both align with the Y direction and hence with each other. This helps minimize image deterioration due to wavelength dependence of the HOE 23.

In the eyepiece prism 21, a surface that transmits the image light (for example, the light incidence surface 21a and the surface 21b) can be configured to have an optical power to bend light. In this case, chromatic aberration of magnification occurs due to refraction on the transmission surface, and thus a phenomenon similar to the above-described expansion of a point by the HOE 23 occurs. Considering, however, that, generally, the wavelength dependence of refraction is lower than that of diffraction, it is sufficient to consider only the diffractive power (the wavelength dependence of diffraction).

In this embodiment, of the surfaces which form the eyepiece prism 21, those which transmit the image light are, except the surface 21d with which the HOE 23 makes contact, (namely the light incidence surface 21a and the surface 21b are) flat surfaces so that the above-described effect of the wavelength independence of refraction can be almost ignored.

In this embodiment, the surface 21d has such a curvature as to be concave on the optical pupil P side in the X direction; in a configuration where a surface of the eyepiece prism 21 that transmits the image light has an optical power, the surface 21d may have such a curvature as to be convex on the optical pupil P side in the X direction.

(HMD)

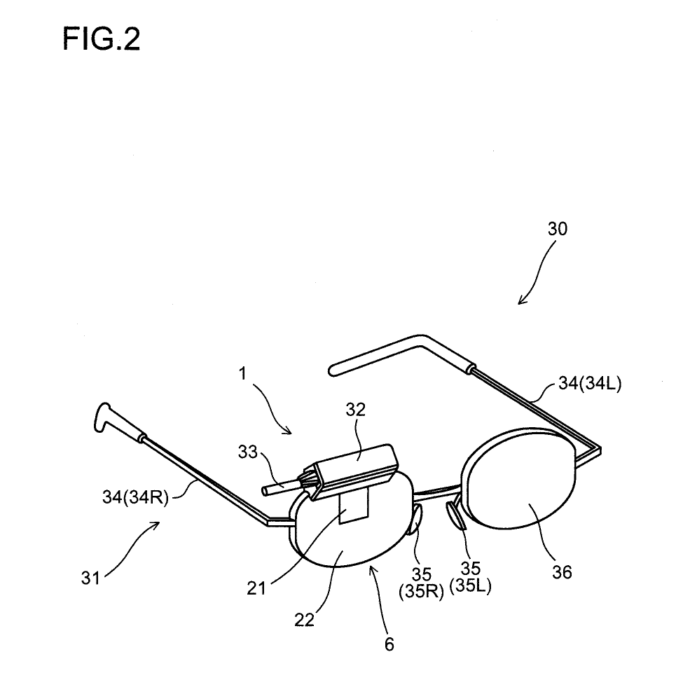

FIG. 2 is a perspective view showing an outline of a structure of an HMD 30 provided with a video display device 1 according to the embodiment. The HMD 30 is composed of the above-described video display device 1 and a support member 31.

The illumination optical system 2, the display element 5, etc. of the video display device 1 are housed in a case 32, and the upper part of the eyepiece optical system 6 is also located in the case 32. As described previously, the eyepiece optical system 6 is composed of the eyepiece prism 21 and the deflection prism 22 bonded together so as to be formed like one of the lenses of spectacles (in FIG. 2, the lens for the right eye) as a whole. Moreover, the light source 11 and the display element 5 in the case 32 are connected via a cable 33 provided through the case 32 to an unillustrated circuit board, and driving electric power and an image signal are supplied from the circuit board to the light source 11 and the display element 5.

The video display device 1 may be configured to be further provided with an imaging device which takes static images and moving images, a microphone, a speaker, an earphone, etc., and to be capable of exchanging (transmitting/receiving) information of taken and displayed images and sound information with an external server or terminal via a communication network such as the Internet.

The support member 31 is a supporting mechanism corresponding to a frame of spectacles, and supports the video display device 1 in front of an observer's eye (in FIG. 2, in front of the right eye). The support member 31 includes temples 34 (a right temple 34 R and a left temple 34 L), which abut on the left and right sides of the observer's head, and nose pads 35 (a right nose pad 35 R and a left nose pad 35 L), which abut on the observer's nose. The support member 31 also supports a lens 36 in front of the observer's left eye; this lens 36 is a dummy lens.

When the HMD 30 is worn on an observer's head and an image is displayed on the display element 5, the image light is directed via the eyepiece optical system 6 to the optical pupil. Thus, by placing his or her pupil at the position of the optical pupil, the observer can observe an enlarged virtual image of the image displayed by the video display device 1. Moreover, the observer can simultaneously observe via the eyepiece optical system 6 the outside-world image on a see-through basis.

In this way, the video display device 1 is supported by support member 31 so that an observer can observe the image offered by the video display device 1 in a handsfree manner, stably for a long period of time. Two of such video display devices 1 may be used to allow observation of the image with both eyes.

### Example

Now, a numerical example of the video display device 1 shown in FIG. 1 will be described more specifically with reference to its construction data, etc.

In the construction data shown below, Si (i=1, 2, 3, . . . ) represents the i-th surface counted from the optical pupil P side along the optical path from the light source 11 to the optical pupil P (with the image light emergence surface of the eyepiece prism 21 taken as the first surface). Thus, S2 represents the surface 21d of the eyepiece prism 21 (the HOE attachment surface), S3 represents the surface 21b (the total reflection surface (the same flat surface as S1)), S4 represents the surface 21c (the total reflection surface), S5 represents the surface 21a (the PBS attachment surface), S6 represents the transmission surface of the PBS 4, S7 represents the cover glass surface of the display element 5, S8 represents the liquid crystal surface of the display element 5, S9 represents the cover glass surface of the display element 5, S10 represents the reflection surface of PBS 4, S11 represents the emergence surface of the polarizing plate 3, S12 represents the interface between the polarizing plate 3 and the diffuser plate 13, S13 represents the incidence surface of the diffuser plate 13, S14 represents the reflection surface of the illumination mirror 12, and S15 represents the LED light emission surface of the light source 11.

The position of each surface Si is identified by surface data consisting of the coordinates (x, y, z) of its vertex and its rotation angle (ADE). The coordinates of the vertex of a surface Si are given, with the vertex taken as the origin of a local rectangular coordinate system (X, Y, Z), in terms of the coordinates (x, y, z) of the origin of the local rectangular coordinate system (X, Y, Z) in a global rectangular coordinate system (x, y, z) (coordinates being given in mm). The inclination of a surface Si is given in terms of the angle of its rotation about its vertex with respect to the x axis (its x rotation). Rotation angles are given in degrees, a counter-clockwise direction of rotation as seen from the positive side of the X axis (as seen from front to rear with respect to the plane of FIG. 1) being the positive direction of a rotation angle.

Moreover, the global rectangular coordinate system (x, y, z) is an absolute coordinate system that coincides with the local rectangular coordinate system (X, Y, Z) of the emergence surface (S1). On the emergence surface (S1), the direction from the emergence surface (S1) toward the HOE 23 is the +Z direction, the upward direction with respect to the emergence surface (S1) is the +Y direction, and the direction perpendicular to the YZ flat plane and pointing from rear to front with respect to the plane of FIG. 1 (the direction from left to right when the HMD was worn) is the +X direction.

Moreover, the production wavelength (HWL; a normalized wavelength), at the time of fabrication, of the HOE used in the example and its reproduction wavelength are both 532 nm, and the diffraction light used is of order 1.

Moreover, in this example, the HOE performs complicated wavefront reconstruction, and therefore the HOE is defined by a phase function φ. The phase function φ is, as shown in formula (1) below, a generating polynomial (two-dimensional polynomial) with respect to the position on the HOE (X, Y). In formula (1), A (i, j) represents the coefficient (HOE coefficient) for XⁱY^{j}.

φ=ΣΣA(i,j)XⁱY^{j} [Formula 1]

Moreover, in the construction data, the shape of the polynomial free-form curved surface is expressed by formula (2) below. Z represents the amount of sag (mm) in the Z-axis direction (in the optical axis direction) at the position of coordinates (X, Y). A (i, j) represents the coefficient (free-form curved surface coefficient) for XⁱY^{j}. No part of formula (2) represents a spherical surface term.

Z=ΣΣA(i,j)XⁱY^{j} [Formula 2]

Table 1 lists the coordinates of each surface in the video display device 1 of this example, and Tables 2 to 4 list, with respect to the video display device 1, coefficients (HOE coefficients) A (i, j) for the phase function φ of the HOE, the shape formula coefficients of the HOE surface (the HOE attachment surface), and the shape formula coefficients of the illumination mirror, for different orders of X and Y respectively. The shape formula coefficients of the HOE and the illumination mirror are given in terms of coefficients of the free-form curved surface given by formula (2). In Tables 2 to 4, different orders X are given in the first row, and different orders of Y are given in the first column. Moreover, in all tables, any coefficient of an unlisted order equals zero, and “E−n” stands for “×10⁻ⁿ”.

TABLE 1

| SURFACE | | x | y | z | ADE(°) |
|---|---|---|---|---|---|
| S15 | LED LIGHT EMISSION SURFACE | 0.00 | 28.19 | −1.68 | 150.32 |
| S14 | ILLUMINATION MIRROR | 0.00 | 24.04 | 6.41 | 2.93 |
| S13 | DIFFUSER PLATE | 0.00 | 22.13 | 3.16 | 53.78 |
| S12 | INTERFACE BETWEEN POLARISING PLATE | 0.00 | 21.93 | 3.02 | 53.78 |
| | AND DIFFUSER PLATE | | | | |
| S11 | POLARISING PLATE | 0.00 | 21.36 | 2.60 | 53.78 |
| S10 | PBS REFLECTION SURFACE | 0.00 | 19.29 | 0.44 | −91.22 |
| S9 | LIQUID CRYSTAL COVER GLASS | 0.00 | 22.45 | −4.81 | −34.68 |
| | INCIDENCE SURFACE | | | | |
| S8 | LIQUID CRYSTAL SURFACE | 0.00 | 22.85 | −5.38 | 145.32 |
| S7 | LIQUID CRYSTAL COVER GLASS | 0.00 | 22.45 | −4.81 | 145.32 |
| | INCIDENCE SURFACE | | | | |
| S6 | PBS | 0.00 | 19.29 | 0.44 | 88.78 |
| S5 | PBS ATTACHMENT SURFACE | 0.00 | 18.59 | 0.42 | 88.78 |
| S4 | TOTAL REFLECTION SURFACE | 0.00 | 11.50 | 5.00 | 0.00 |
| S3 | TOTAL REFLECTION SURFACE(SAME FLAT | 0.00 | 4.00 | 0.00 | 180.00 |
| | SURFACE AS EMERGENCE SURFACE) | | | | |
| S2 | HOE SURFACE | 0.00 | −0.50 | 2.50 | −31.00 |
| S1 | EMERGENCE SURFACE | 0.00 | 0.00 | 0.00 | 0.00 |

TABLE 2
<HOE COEFFICIENTS>

| | X | | | | |
|---|---|---|---|---|---|
| Y | 0 | 2 | 4 | 6 | 8 |
| 1 | 0.0000E+00 | 1.0929E−04 | −2.0337E−08 | 2.9047E−10 | −1.2125E−12 |
| 2 | −1.3770E−02 | −2.8925E−06 | 3.9495E−08 | −4.4937E−10 | 1.6690E−12 |
| 3 | 2.2715E−04 | 3.2085E−08 | 7.1422E−10 | −2.0575E−12 | 0.0000E+00 |
| 4 | −9.6669E−06 | 2.3061E−08 | −2.0714E−10 | 2.0210E−12 | 0.0000E+00 |
| 5 | −2.5603E−07 | −4.4426E−09 | −1.1721E−11 | 0.0000E+00 | 0.0000E+00 |
| 6 | 8.9449E−08 | −1.7840E−10 | 4.5787E−13 | 0.0000E+00 | 0.0000E+00 |
| 7 | 1.5597E−08 | 6.4702E−11 | 0.0000E+00 | 0.0000E+00 | 0.0000E+00 |
| 8 | −2.2360E−09 | −1.3842E−12 | 0.0000E+00 | 0.0000E+00 | 0.0000E+00 |
| 9 | −1.8977E−10 | 0.0000E+00 | 0.0000E+00 | 0.0000E+00 | 0.0000E+00 |
| 10 | 2.4227E−11 | 0.0000E+00 | 0.0000E+00 | 0.0000E+00 | 0.0000E+00 |

TABLE 3
<SHAPE FORMULA COEFFICIENTS OF HOE SURFACE>

| | X | | | | |
|---|---|---|---|---|---|
| Y | 2 | 4 | 6 | 8 | 10 |
| 0 | −8.5942E−03 | −1.0800E−06 | −6.0420E−10 | 2.1902E−11 | −1.3449E−13 |

TABLE 4
<SHAPE FORMULA COEFFICIENTS OF ILLUMINATION MIRROR>

X

| Y | 0 | 2 |
|---|---|---|
| 0 | 0.0000E+00 | −1.2477E−02 |
| 2 | −2.5786E−02 | 0.0000E+00 |
| 3 | −5.5959E−04 | 0.0000E+00 |
| 4 | −8.5243E−06 | 0.0000E+00 |

In this example, as shown in Table 2, the HOE coefficients in all terms of order 0 for Y equal zero; moreover, no part of Formula (2) represents a spherical surface term, and thus the HOE has a zero diffractive power in the X direction. Moreover, as shown in Table 3, the shape formula coefficients of the HOE surface are non-zero in terms of order 0 for Y and of even orders for X (in the range from 2 to 10), and are zero in all terms of orders non-zero for Y. This indicates that the HOE surface has a curvature in the X direction, but has no curvature in the Y direction. With this configuration, the direction in which a point expands due to wavelength dependence (diffractive power) of the HOE is limited to the up/down direction. This helps alleviate deterioration of image quality as compared with the conventional configuration where the image expands in radial directions.

(Supplementary Notes)

The video display device presented in this embodiment may be configured as follows.

(1) The surface of the eyepiece prism with which the HOE makes contact may have such a curvature as to be concave on the optical pupil side in the X direction.

(2) The HOE may have a positive diffractive power in the Y direction.

(3) The direction in which the image light is reflected on the surface of the eyepiece prism with which the HOE makes contact is substantially aligned with the direction in which the image light is diffracted by the HOE at the position corresponding to the center of the screen in the HOE.

(4) A video display device may be provided with a polarizing plate which transmits, out of the light from an illumination optical system, light with a predetermined polarization direction, and a polarizing beam splitter which on one hand reflects the light transmitted through the above-described polarizing plate in the direction of a reflective liquid crystal display element as a display element and which on the other hand transmits, out of the light reflected from the reflective liquid crystal display element, light of which the polarization direction is orthogonal to that of the incidence light (light corresponding to an ON-state of an image signal). The above-described polarizing beam splitter is attached to a light incidence surface of the eyepiece prism.

Moreover, the HMD presented in this embodiment may be configured to support the above-described video display device with a support member.

### INDUSTRIAL APPLICABILITY

Video display devices according to the present invention find applications in HMDs.

### LIST OF REFERENCE SIGNS

1 video display device
2 illumination optical system
5 display element
6 eyepiece optical system
21 eyepiece prism
21d surface
23 HOE (volume-phase hologram)
30 HMD (head-mounted display)
31 support member

1. A video display device comprising:
a display element displaying an image by modulating light from an illumination optical system; and
an eyepiece optical system directing image light from the display element to an observer's pupil, wherein
the eyepiece optical system includes:
an eyepiece prism guiding the image light inside the eyepiece prism; and
a volume-phase hologram arranged in contact with the eyepiece prism, the volume-phase hologram reflecting and diffracting the image light guided inside the eyepiece prism,
a surface of the eyepiece prism with which the volume-phase hologram makes contact has a zero curvature in one direction, but has a non-zero curvature in a direction perpendicular to the one direction, and
the volume-phase hologram has a non-zero diffractive power in the one direction, but has a zero diffractive power in the direction perpendicular to the one direction.

2. The video display device of claim 1,
wherein, of surfaces which form the eyepiece prism, a surface which transmits the image light is, except the surface with which the volume-phase hologram makes contact, a flat surface.

3. The video display device of claim 1,
wherein the display element has a rectangular display surface, and a shorter-side direction of the display surface aligns with the one direction in which the surface with which the volume-phase hologram makes contact has a zero curvature.

4. (canceled)

5. The video display device of claim 2,
wherein the display element has a rectangular display surface, and a shorter-side direction of the display surface aligns with the one direction in which the surface with which the volume-phase hologram makes contact has a zero curvature.

6. The video display device of claim 1,
wherein the surface of the eyepiece prism with which the volume-phase hologram makes contact has such a curvature as to be concave on an optical pupil side in the direction in which the surface of the eyepiece prism with which the volume-phase hologram makes contact has a non-zero curvature.

7. The video display device of claim 5,
wherein the surface of the eyepiece prism with which the volume-phase hologram makes contact has such a curvature as to be concave on an optical pupil side in the direction in which the surface of the eyepiece prism with which the volume-phase hologram makes contact has a non-zero curvature.

8. The video display device of claim 1,
wherein the volume-phase hologram has a positive diffractive power in the direction in which the surface of the eyepiece prism with which the volume-phase hologram makes contact has a zero curvature.

9. The video display device of claim 6,
wherein the volume-phase hologram has a positive diffractive power in the direction in which the surface of the eyepiece prism with which the volume-phase hologram makes contact has a zero curvature.

10. The video display device of claim 7,
wherein the volume-phase hologram has a positive diffractive power in the direction in which the surface of the eyepiece prism with which the volume-phase hologram makes contact has a zero curvature.

11. The video display device of claim 1,
wherein a direction in which the image light is reflected on the surface of the eyepiece prism with which the volume-phase hologram makes contact is substantially aligned with a direction in which the image light is diffracted by the volume-phase hologram at a position corresponding to a center of a screen
in the volume-phase hologram.

12. The video display device of claim 10,
wherein a direction in which the image light is reflected on the surface of the eyepiece prism with which the volume-phase hologram makes contact is substantially aligned with a direction in which the image light is diffracted by the volume-phase hologram at a position corresponding to a center of a screen in the volume-phase hologram.

13. The video display device of claim 1, further comprising:
a first polarizing element which polarizes the light from the illumination optical system; and
a second polarizing element which reflects the light from the first polarizing element and transmits the image light from the display element,
wherein the display element is a reflective liquid crystal display element.

14. The video display device of claim 13,
wherein the second polarizing element is attached to a light incidence surface of the eyepiece prism.

15. A head-mounted display comprising:
the video display device of claim 1; and
a support member which supports the video display device in front of an eye of an observer.

16. A head-mounted display comprising:
the video display device of claim 10; and
a support member which supports the video display device in front of an eye of an observer.
